(19) United States
(12) Patent Application Publication
(10) Pub. No.: US 2005/0226706 A1
(43) Pub. Date: Oct. 13, 2005

(54) Cargo handling system

(76) Inventor: James A. Thomas, Spencerville, IN (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(21) Appl. No.: 10/780,369

(22) Filed: Feb. 17, 2004

(51) Int. Cl. B62B 1/00

(52) U.S. Cl. 414/467

(57) ABSTRACT

A handling system for incorporation in a trailer is used with palletized freight. The handling system incorporates a segmented, translatable platform. Among the segments is a principal or main segment which supports the palletized freight during shipping. The main upper surface of each of the segments is a conveyor. The conveyors are aligned from segment to segment to allow cooperative movement, respacing and unloading of the palletized freight on and between the segments and off of an end segment. The platform translation system allows the platform to be extended from an open end or side of the trailer. The segmentation of the platform allows the end and a mid segment to lower a piece of palletized freight to a surface below the level of the main segment of the platform.

### BACKGROUND OF THE INVENTION

1. Technical Field

The invention relates to an onboard load transfer system for trucks which minimizes the direct labor requirements for off loading cargo from truck trailers.

2. Description of the Problem

The off loading of cargo from a truck is typically intensive in its use of labor and materials handling equipment. Loading docks are frequently understaffed and under equipped, at least for handling peak traffic periods, and the lack of equipment and personnel often delays truckers. Sometimes deliveries must be made to locations with no dock at all. Various automated or semi-automated solutions have been proposed for loading and off loading truck trailers, but the implementation of many of these proposals requires an increased capital investment in dock facilities. Dock facility operators who are already operating their docks with a minimum investment in equipment, and with as few workers as possible, and thus are the cause of the delays, would seem to have little economic incentive to invest in such equipment since its financial benefit would primarily flow to the truck operators. Nor is there any assurance of standardization between docks implementing solutions that would work for all trucks.

Fewer solutions to this problem have been directed to the truck trailer. Trailers of course present constraints on space and weight capacity for carrying elaborate materials handling systems. Any onboard solution must fit on or within the trailer and should not pose an excessive weight penalty. There is also the need to meet the demands of off loading trucks at different types of dock facilities, or a complete lack of a dock.

### SUMMARY OF THE INVENTION

According to the invention there is provided a handling system for incorporation in a trailer for use with palletized freight. The handling system incorporates a segmented, translatable platform. Among the segments is a principal or main segment which supports the palletized freight during shipping. The main upper surface of each of the segments is a conveyor. The conveyors are aligned from segment to segment to allow cooperative movement, respacing and offloading of the palletized freight on and between the segments and off of an end segment. The platform translation system allows the platform to be extended from an open end or side of the trailer. The segmentation of the platform allows use of the end and a mid segment to lower a piece of palletized freight to a surface below the level of the main segment of the platform.

Additional effects, features and advantages will be apparent in the written description that follows.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a perspective view in partial cutaway of a trailer illustrating operation of a preferred embodiment of the invention.

FIG. 2 is a perspective view in partial cutaway of a trailer further illustrating operation of the preferred embodiment in different environment.

FIG. 3 is a perspective view illustrating horizontal translation of the palletized freight handling system of the invention and the vertical repositioning of segments thereof.

FIG. 4 is a side elevation of the same processes of FIG. 3.

FIG. 5 is a side elevation of the translatable platform of a preferred embodiment of the invention.

FIG. 6 is a side elevation of the translatable platform of the preferred embodiment as installed on a trailer having height a height adjusting suspension system.

FIG. 7 is a side elevation of the translatable platform extended from a trailer as used to reposition palletized freight.

FIG. 8 is a top plan view of a trailer bed on which the translatable platform has been installed.

FIG. 9 is a cross sectional view of a wheel assembly for supporting the platform in a track on a trailer bed.

FIG. 10 is a cross sectional view of a segment-to-segment joint allowing rotation about a horizontal axis.

FIG. 11 is a schematic illustration of use of the platform to move and unload palletized freight.

FIG. 12 is a schematic of a control system for the palletized freight handling system.

### DETAILED DESCRIPTION OF THE INVENTION

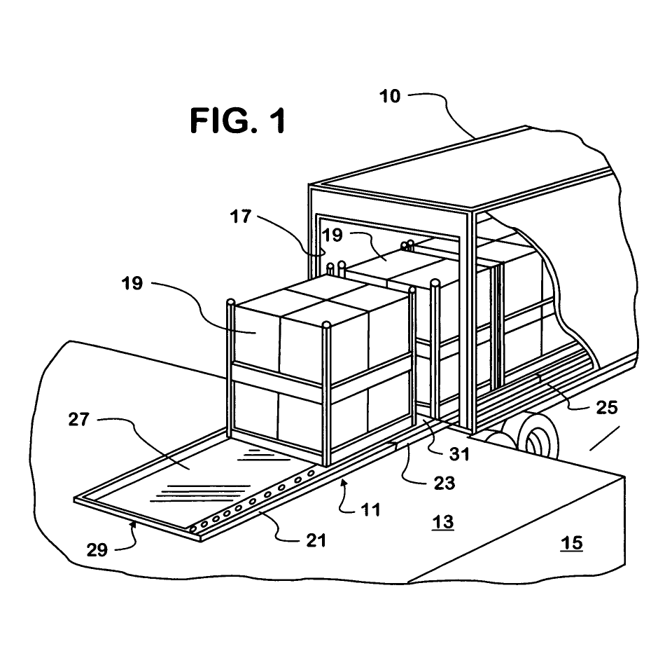

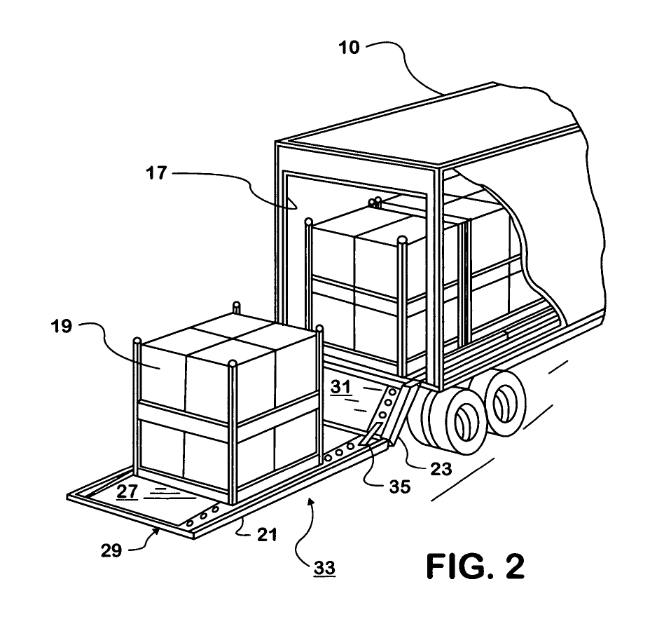

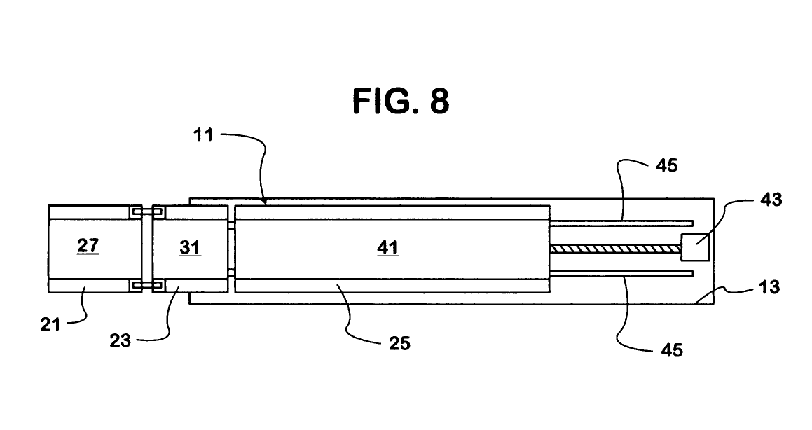

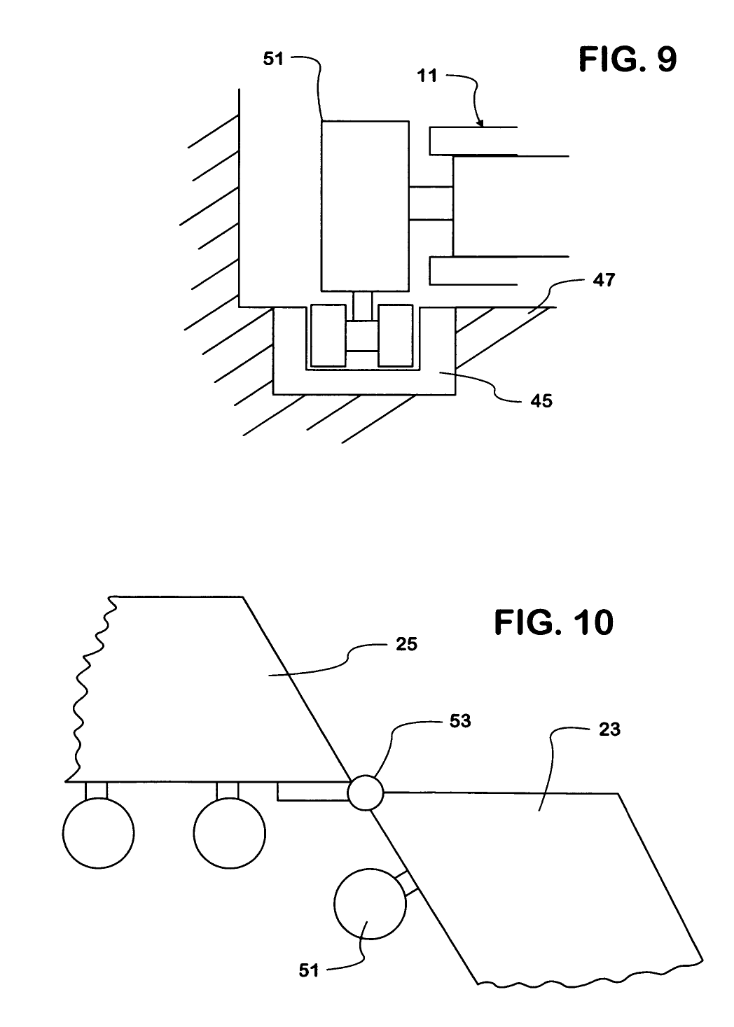

Referring now to the figures and in particular to FIGS. 1 and 2, a trailer 10 incorporating a translatable, segmented platform 11 for palletized freight is shown. Translatable platform 11 is, in its retracted position within trailer 10 and fully supported on the bed of the trailer (see FIGS. 8, 9) and may be repositioned as a unit off the bed through an opening in the trailer, such as end opening 17. As shown in FIG. 1, the portion of translatable, segmented platform 11 moved out of the trailer may come to rest on the upper or target surface 13 of a raised loading dock 15. Translatable, segmented platform 11 provides a support floor for a plurality of palletized freight modules 19. The preferred embodiment of the invention works best with freight that is bundled into standard sizes with a standard orientation, here termed palletized units, although it is not intended that the invention as claimed be limited to freight of such character.

Translatable, segmented platform 11 comprises three segments in the preferred embodiment, including an end segment 21, a mid segment 23 and a main segment 25. Each segment has a distinct function and each segment has its own, independently actuable conveyor. These include an end segment conveyor 27 and a mid segment conveyor 31. End segment 21 is articulated with mid segment 23 along adjacent edges and mid segment 23 is articulated with main segment 25 along common edges. The axes of articulation are parallel and horizontally disposed allowing mid segment 23 to be rotated downwardly from one end of main segment 27 and end segment 21 to be rotated upwardly from one edge of mid segment 23. Hydraulic pistons including hydraulic piston 35, connected between mid segment 23 and end segment 21, are used to rotate the segments. This allows end segment 21 to be lowered to and placed parallel on a supporting surface 33 while remaining flat. End conveyor 27, mid segment conveyor 31 and the conveyor for main segment 25 are aligned for cooperation and may be operated in a fashion to separate the end or “current last in” palletized unit 19 from the remaining units. This separation allows the current last in palletized unit to lowered to the target surface 33 on segment 21 and moved off of end segment 21 at end 29.

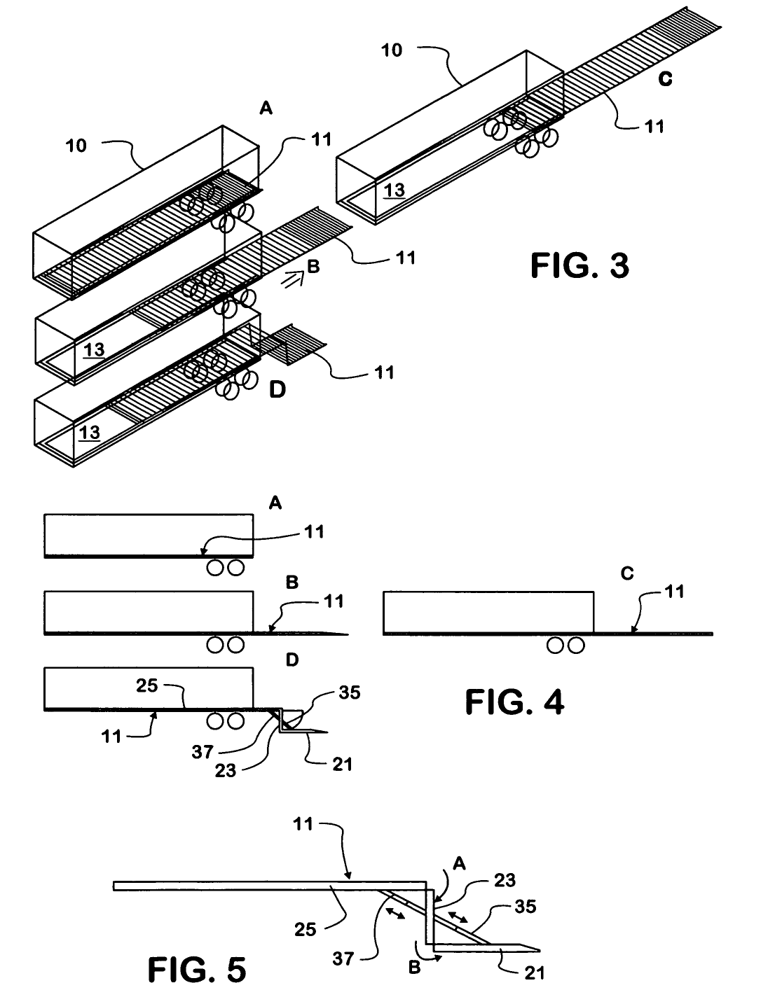

Referring now to FIGS. 3 and 4 translation and positioning of the segments of platform 11 is illustrated. Translation of the segments occurs as a unit, that is platform 11 may be moved horizontally in and out trailer 10 from a fully retracted position (A) on bed 13, to an intermediate position (B) and finally to a position of maximum extension (C) where only a small portion of the platform remains in trailer 10 and supported on the bed. Translation occurs through an opening in the trailer, typically at one end of the trailer, although it is conceivable that it could be done toward a side of the trailer. Platform 11 is illustrated in a reconfigured shape (D) where mid segment 23 has been rotated in a clockwise direction A as viewed in FIG. 5 and end segment 21 has been simultaneously and synchronously rotated in a counterclockwise direction B to drop the level of end segment 21 below the level of main segment 25. Hydraulic pistons 35 and 37 are pivotally coupled between end segment 21 and mid segment 23 (for piston 35) and mid segment 23 and main segment 25 (for piston 37). Contraction of the pistons operates to introduce a fold in the platform 11 as illustrated in FIG. 5, while extension of the pistons straightens the platform. Strain on midsegment 23 is minimized by providing that the points of attachment of hydraulic pistons 35 and 37 on midsegment 23 are collocated.

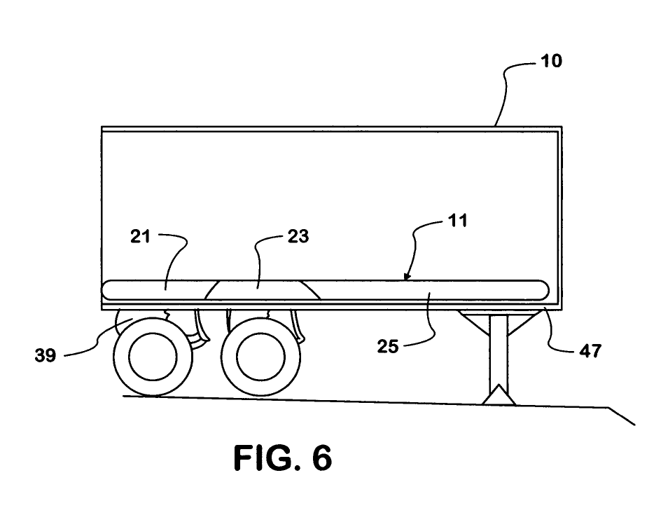

As illustrated in FIG. 6, translatable, segmented platform 11 is installed on the bed 47 of trailer 10, and is preferably made as compact as possible in the vertical dimension to minimize the amount of space occupied. Freight is preferably kept on main segment 25 during shipping, but the trailer may be filled, with cargo carried on all of the segments if the destination has a raised dock. Otherwise, enough of platform 11 must be kept clear of cargo to allow mid segment 23 to be cleared of pallets for rotation out of the horizontal when it is necessary to lower end segment 21. It is conceivable that platform 11 could be adapted to fold end segment 21 and mid segment 23 upwardly within trailer 10 to conserve space, or that the two segments could be detached from the main segment and carried beneath the bed. Either adaptation can be expected to add considerable mechanical complexity to the system.

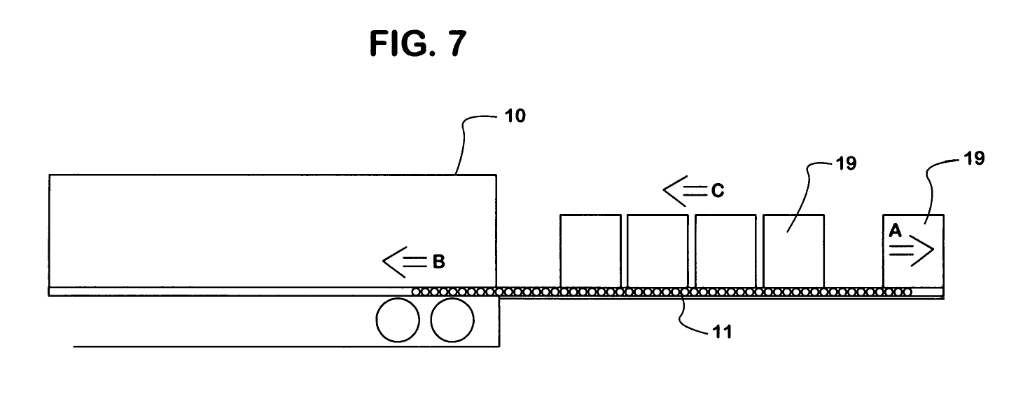

Conveyors can operate simultaneously with translation of the translatable, segmented platform 11. As illustrated in FIG. 7, platform 11 is being withdrawn into trailer 10 in the direction indicated by the letter B while end conveyor 27 moves a pallet 19 off the end of the platform. Preferably the velocity of platform 11 cancels the velocity of the upper surface of conveyor 27 relative to the ground so that the velocity of the current last in palletized object 19 is also zero relative to the surface on to which it is transferred. Simultaneously, the remaining palletized objects 19 are moved toward the opposite end of platform 11 at the same time the platform is withdrawn into the trailer. Motion may be ramped up and down to avoid tumbling the cargo on account of its inertia.

Translation of platform 11 is preferably confined to a straight line. Referring to FIG. 8, it may be seen that platform 11, within trailer 10, rolls along parallel tracks 45 running lengthwise along the bed 13 of trailer 10. Translatable, segmented platform 11 may be moved by any number of devices. Here a translation mechanism 43 is provided by an elongated worm gear coupled into the main segment 25. Conveyors 27, 31 and 41 are located to provide the upper surfaces of end segment 21, mid segment 23 and main segment 25, respectively. The worm gear translation mechanism is coupled to main segment 25 below the level of conveyor 41. The conveyors are aligned on one another and travel on parallel axles allowing packages to be freely moved from one conveyor to an adjacent conveyor.

Each segment of translatable, segmented platform 11 comes with a plurality of wheel assemblies 51 such as illustrated in FIG. 9 which extend from the sides (or from the bottoms of the segments along the sides) of the segments aligned with the direction of travel of the platform. Wheel assemblies 51 are set in the tracks 45 allowing to and fro movement of platform 11 in the direction of elongation of the tracks.

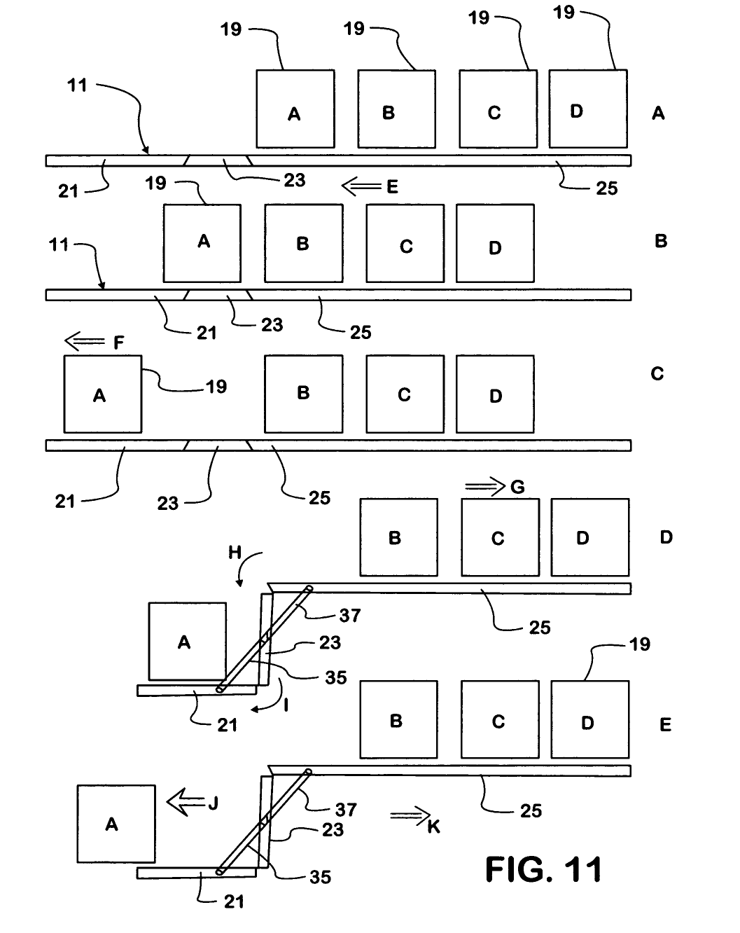

Referring to FIG. 10 a hinge or joint 53 providing articulation between main segment 25 and mid segment 23 is illustrated. Joint 53 is located along the lower surfaces of the segments and toward the outside edge of the segments allowing mid segment to articulate downwardly from main segment 25. A similar joint is provided between mid segment 23 and end segment 21, except that it is located along the top surfaces, outside of the conveyors, allowing the end segment 21 to rotate upwardly from the mid segment.

Operation of the translatable, segmented platform 11 is illustrated in FIG. 11. Operation is typically done by the truck operator using a control interface positioned to allow the process to be directly watched. At step A an array of palletized freight units 19 designated A-D are situated on main segment 25 of translatable, segmented platform 11. This is a preferred position for the palletized units 19 during shipping. Where the destination is a facility that requires use of platform 11 to lower palletized units 19 enough space must be left on platform 11 to allow the palletized units to be positioned so that mid segment 23 is clear of any units. One palletized unit 19 is positioned on end segment 21 during lowering operation.

Moving to step B the process of repositioning palletized units 19 is illustrated. Conveyors installed on main segment 25, mid segment 23 and end segment 21 operate to move all four palletized units toward the end segment. Once the current last in palletized unit 19, designated A, is fully off of main segment 25, the conveyor for main segment 25 stops while the conveyors for mid segment 23 and end segment 21 continue to run until the current last in palletized unit 19 is fully off of the mid segment and preferably positioned centered on end segment 21 as illustrated in step C.

The palletized unit 19 disposed on end segment 21 may or may not need to be lowered to ground level. The process is illustrated as including a lowering step D. Mid segment 23 is pulled by pneumatic actuators 37 contracting to rotate the segment counter-clockwise as indicated at H. Simultaneously, end segment 21 is kept level by retraction of pneumatic actuators 35, the segment rotating clockwise synchronously with mid segment 23 as indicated by the letter 1. Sensors may disposed on the bottom of end segment 21 to determine when the segment is fully supported from underneath. Next, at step E, translatable, segmented platform 11 is withdrawn in the direction indicated by the letter K while the conveyor for end segment operates to move the “A” palletized unit 19 off of the end of end segment 21. Palletized unit 19 preferably has a zero velocity relative to the target surface.

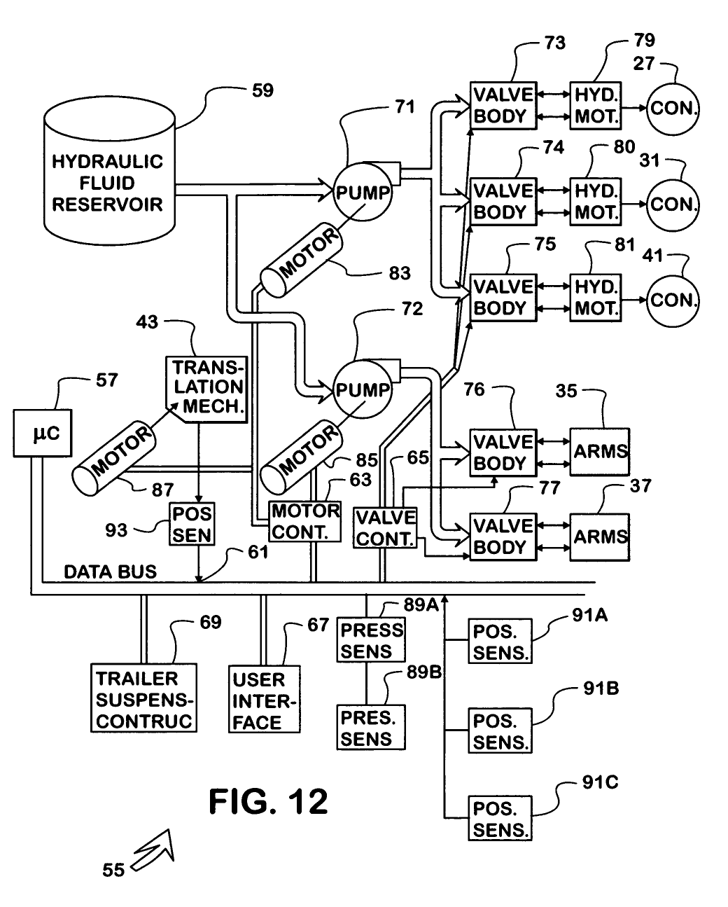

Referring to FIG. 12 a control system 55 is illustrated in schematic form for a preferred embodiment of the invention. Control system 55 relates primarily to positioning and articulation of translatable, segmented platform 11, and the movement of the conveyors 27, 31 and 41, but also provides for transferring information to a trailer suspension control system for adjusting the height of trailer 10. Control system 55 is primarily directed to control of hydraulic actuators, but those skilled in the art will comprehend that the system can be applied to non-hydraulic systems. The central component of control system 55 is a programmable microcontroller 57 which receives requests for operation of system elements over a data bus 61 to which it is coupled and which transmits requests from a user interface 67. User interface 67 may be implemented in any number of ways, and may be made configurable to reflect the character of the system elements using a touch screen.

Hydraulic fluid is stored in a reservoir 59 and delivered by a hydraulic circuit to pumps 71 and 72. Pump 71 supports operation of the conveyors 27, 31 and 41. The hydraulic circuit supporting conveyor operation includes three valve bodies 73, 74 and 75 which deliver fluid to hydraulic motors 79,80 and 81, respectively, to operate motors 79-81 in either of two directions. Since each motor is controlled by its own valve body, the motion of the conveyors may be coordinated, or independent of the remaining conveyors. A valve controller 65 coupled to data bus 61 controls operation of the valve bodies 73-75 under instruction of microcontroller 57.

Hydraulic fluid is also pressurized by a second hydraulic pump 72 which provides hydraulic fluid to valve bodies 76 and 77, which are used to control the extension and retraction of pneumatic arms 35 and 37. Valve controller 65 is also used for controlling valve bodies 76 and 77.

Translation of platform 11 is performed by a translation mechanism 43, which may be implemented in a worm gear arrangement or other mechanical arrangement for converting rotational motion of a motor 87 to linear movement. Additional motors 83 and 85 are provided for pumps 71 and 72, respectively. All three motors are under the control of a motor controller 63. Motor controller 63 operates under the control of microcontroller 57. Feedback to the operator over interface 67 may be provided by the inclusion of sensors which generate information relating to the position of packages on the platform, support of the platform from below, or extent of extension of platform 11. To this end various pressure sensors 89A-B, position sensors 91 A-C and translation extension sensor 93 may be provided. Pressure sensors 89A and B may provide operational information relating to status of the hydraulic circuits. Position sensors 91A-C may be various types of transducers used to locate palletized units 19 or the location of segments. Lastly, data bus 61 is coupled, either directly or indirectly, to a trailer suspension control system 69 to allow the trailer height to be adjusted to bring the bed of the trailer level with a raised dock.

The invention provides a compact, on board cargo handling system for a trailer which is useable at both improved and unimproved locations for unloading of cargo. While not directed to cargo loading, the system can be used to reposition cargo on board without the need to drive a forklift truck onto the bed of the vehicle.

While the invention is shown in only one of its forms, it is not thus limited but is susceptible to various changes and modifications without departing from the spirit and scope of the invention.

1. A load support and transfer platform for use in moving objects off of a mobile, rectangular bed, the load support and transfer platform comprising:
first, second and third segments disposed end to end in alignment with an end of the rectangular bed, the first and second segments being articulated and the second and third segments being articulated;
an extension mechanism for moving the first, second and third segments as a unit partially off the rectangular bed by way of the end;
each of the first, second and third segments having an independently actuable conveyor forming an upper surface of its respective segment and operable to allow an object supported by one of the segments to be transferred to another segment or off one end of the load support and transfer platform; and
a positioning mechanism for vertically repositioning the first segment.

2. The load support and transfer platform as set forth in claim 1, further comprising:
a truck trailer providing the mobile bed.

3. The load support and transfer platform as set forth in claim 2, further comprising:
a controller for extending and retracting the first, second and third segments as a unit and for operating the conveyors to move a last in object to the first segment for deposition of the last in object on an external surface, the controller being responsive to inputs for moving all of a plurality of objects supported on the load support and transfer platform toward the first segment and cutting movement of the conveyor for the third member to separate the last in object from the remaining objects while continuing to move the last in object toward the first segment.

4. The load support and transfer platform as set forth in claim 3, further comprising:
the first segment being a terminal member located closest to an openable end of the trailer when the load support and transfer platform is fully retracted;
the second segment being an intermediate member articulated between the first and third members; and
the third segment being a primary support member.

5. The load support and transfer platform as set forth in claim 4, further comprising:
the controller providing for retracting the first, second and third segments into the trailer while the conveyor for the first segment continues to move the last in object off the first segment at zero velocity relative to the ground.

6. The load support and transfer platform as set forth in claim 5, further comprising:
a trailer height adjustment mechanism.

7. Apparatus comprising:
a trailer;
a main conveyor section providing a support surface for cargo;
a mid conveyor section abutting the main conveyor section along an edge of each;
an end conveyor section abutting the mid conveyor section along an edge of the mid conveyor section opposite the edge abutting the main conveyor section;
a track installed on the trailer and supporting the main, mid and end conveyor sections in the trailer for horizontal movement within and out from the trailer;
the mid conveyor section and main conveyor section being articulated allowing the mid conveyor section to rotate through about ninety degrees downwardly from the main conveyor section when not supported by the track or a surface;
the end conveyor section and mid conveyor section being articulated allowing the end conveyor section to rotate through about ninety degrees to remain horizontal while the mid conveyor section is rotated on the main conveyor section; and
and each of the main, mid and end conveyor sections having a conveyor.

8. Apparatus as claimed in claim 7, further comprising:
a trailer suspension control system allowing the height of the truck to be adjusted.

9. Apparatus as claimed in claim 8, further comprising:
a controller for extending the main, mid and end conveyor sections from the trailer as a unit; and
the controller further providing, responsive to operator inputs, for adjusting the height of the truck and the articulation of the mid and end conveyor sections to place the end conveyor section on a target surface for unloading an object from the trailer.

10. Apparatus as claimed in claim 9, further comprising:
the controller providing for selecting from independent and coordinated movement of the conveyors on the main, mid and end conveyor sections for repositioning, modifying spacing between and off loading objects.

11. A trailer onboard handling system for discrete units of freight comprises:
a segmented, translatable platform;
a main segment of the translatable platform for supporting the discrete units during shipping;
a mid segment of the translatable platform attached for rotation on an axis provided by a first horizontal joint to the main segment;
an end segment of the translatable platform attached for rotation to the mid segment on a second horizontal joint parallel to the first horizontal joint;
a conveyor forming the principal upper surface of each of the segments;
the conveyors being aligned from segment to segment to allow cooperative movement, respacing and off loading of the discrete units on and between the segments and off of the end segment; and
a platform translation system for extending and retracting the translatable platform from an open end or side of the trailer.

12. A trailer onboard handling system as claimed in claim 11, further comprising:
a rotation system for the mid and end segments allowing the end segment to be lowered to and placed flat on an external target surface.

13. A trailer onboard handling system as claimed in claim 12, further comprising:
a trailer suspension system allowing the trailer to be raised and lowered.
